(19) United States
(12) Patent Application Publication
(10) Pub. No.: US 2014/0178758 A1
(43) Pub. Date: Jun. 26, 2014

(54) DEVICE FOR PRODUCING AN ELECTRIC CURRENT AND METHOD FOR MAKING THE SAME

(71) Applicant: EPISTAR CORPORATION, Hsinchu City (TW)

(72) Inventors: Chih-Jung CHEN, Hsinchu City (TW); Shu-Fen HU, Hsinchu city (TW); Ru-Shi LIU, Hsinchu city (TW); Tai-Feng HUNG, Hsinchu city (TW)

(73) Assignee: EPISTAR CORPORATION, Hsinchu City (TW)

(21) Appl. No.: 13/726,438

(22) Filed: Dec. 24, 2012

(51) Int. Cl. H01M 4/505; H01M 4/525; H01M 4/583

(52) U.S. Cl. CPC H01M 4/505; H01M 4/583; H01M 4/525
USPC 429/220; 429/231.8; 429/231.3; 429/221; 429/223; 429/224; 29/623.1

(57) ABSTRACT

Disclosed is a device for producing an electric current and a method for making the same. The device for producing an electric current, comprising: an anode comprising a stack formed by alternately stacking of at least one Si layer and at least one carbon material layer, and a LiPON layer on the stack; a cathode; and an electrolyte between the anode and the cathode.

### TECHNICAL FIELD

The application relates to a device for producing an electric current, in particular to a device for producing an electric current having improved electrochemical performance.

### DESCRIPTION OF BACKGROUND ART

As the demand for the portable electronic devices increases, a device for producing an electric current is getting more and more important. Among a variety of devices for producing an electric current, lithium-ion batteries have been widely used for portable electronic devices, and their use as next-generation power sources for electric vehicles and energy storage systems for renewable energy is now being explored. Owing to the ever-increasing applications of lithium-ion batteries, the electrochemical performance has been an issue of concern.

In 1980, Armand proposed the concept of “Rocking Chair Battery” (RCB). In a Rocking Chair Battery, non-metallic anode materials based on the mechanism of intercalation, such as carbon material, are used to replace the lithium metal. The reaction at the anode is the intercalation and deintercalation mechanism of lithium ions instead of the oxidation-reduction reaction of a lithium metal. As a result, the electrochemical performance and safety of the batteries are improved because the negative phenomena such as the “dendritic structure” and “dead Li” due to the oxidation-reduction reaction are avoided.

However, after the first charging and discharging cycle, a solid electrolyte interface is usually formed on the electrode surface of the lithium ion secondary battery so the problem of an initial irreversible capacity is occurred. The initial irreversible capacity results in the reduction of the capacity of the lithium ion secondary battery. Both the initial irreversible capacity and the capacity are important factors in evaluating the electrochemical performance of the lithium ion secondary battery. An improvement on the initial irreversible capacity and the capacity provides the lithium ion secondary battery with a better electrochemical performance to meet the commercial demand.

### SUMMARY OF THE DISCLOSURE

Disclosed is a device for producing an electric current and a method for making the same. The device for producing an electric current, comprising: an anode comprising a stack formed by alternately stacking of at least one Si layer and at least one carbon material layer, and a LiPON layer on the stack; a cathode; and an electrolyte between the anode and the cathode.

### BRIEF DESCRIPTION OF THE DRAWINGS

FIG. 1A illustrates a device for producing an electric current in accordance with one embodiment of the present application.

FIG. 1B illustrates the anode of device for producing an electric current in accordance with one embodiment of the present application.

FIG. 2 shows the X-ray diffraction spectrum of LiPON formed by a method in accordance with one embodiment of the present application (the upper part) and the standard Li₃PO₄ target (the lower part).

FIG. 3 shows the X-ray photoelectron spectroscopy of the LiPON layer formed by a method in accordance with one embodiment of the present application.

FIG. 4 shows the impedance analysis of the LiPON layer formed by a method in accordance with one embodiment of the present application.

FIG. 5 shows a comparison of the capacity of a device for producing an electric current in accordance with one embodiment of the present application with that of a conventional device for producing an electric current.

### DETAILED DESCRIPTION OF PREFERRED EMBODIMENTS

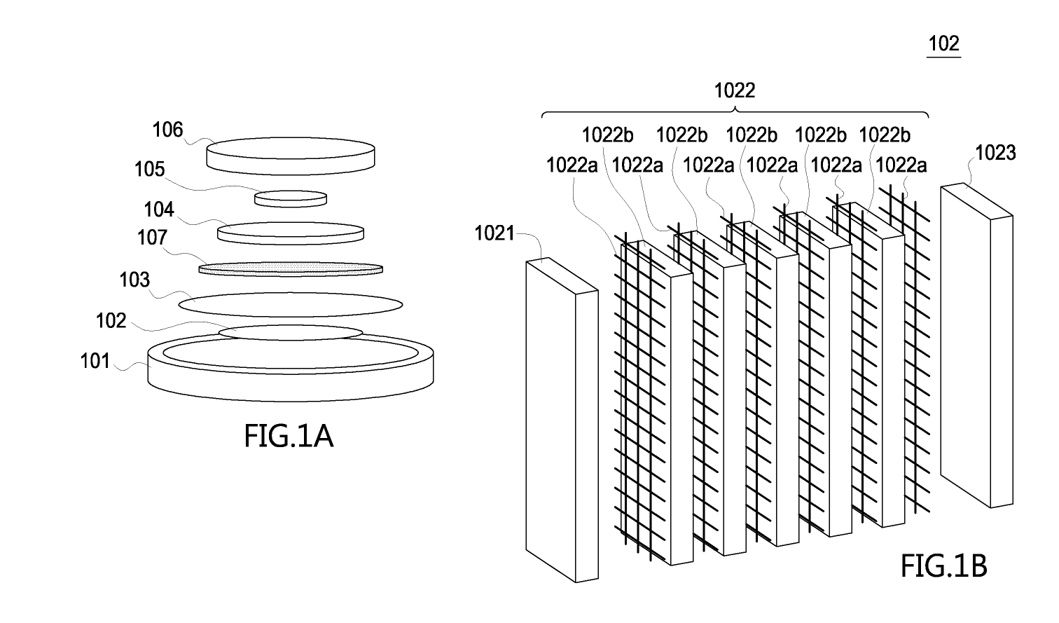

FIG. 1A illustrates a device for producing an electric current in accordance with one embodiment of the present application. The device for producing an electric current comprises a bottom cap 101, an anode 102, a separator 103, an electrolyte 107, a cathode 104, a spring piece 105, and a top cap 106. The bottom cap 101 and the top cap 106 are used to pack other elements and are sealed with the aid of the spring piece 105. The bottom cap 101 and the top cap 106 also function as electrodes of the device for producing an electric current to conduct the produced current out. The material of the bottom cap 101 and the top cap 106 comprises stainless steel. The anode 102 is illustrated in detail in FIG. 1B. The cathode 104 can be LiCoO₂, LiFePO₄, LiNiO₂, and/or LiMn₂O₄ in the present embodiment. The cathode 104 is formed on a gasket (not shown) in this embodiment. The separator 103 comprises macromolecular compounds, such as a polymer material, to separate the anode 102 and the cathode 104, while the lithium ions can still pass through the separator 103 and moves between the anode 102 and the cathode 104 in the electrolyte 107. The electrolyte 107 may be added onto the separator 103 while the bottom cap 101 and the top cap 106 are packed together. The electrolyte 107 comprises an organic solvent and is between the anode 102 and the cathode 104.

FIG. 1B illustrates the anode 102 of the device for producing an electric current in accordance with one embodiment of the present application. The anode 102 comprises a stack 1022 formed by alternately stacking of at least one Si layer 1022a and at least one carbon material layer 1022b and a solid electrolyte interface preventing layer 1023, such as a LiPON (lithium phosphorous oxynitride) layer, on the stack 1022. The carbon material layer 1022b can be a graphene layer. As shown in the figure, in this embodiment, the stack 1022 is formed by alternately stacking of five Si layers 1022a and six carbon material layers 1022b. The capacity of Si (with a theoretical capacity 4200 mAh/g) is much higher than other commercial anode materials. However, the Si layer tends to crack during charging and discharging cycles. Although the capacity of the carbon material is low (for example, the theoretical capacity of graphene is only 374 mAh/g), the structure of the carbon material is stronger than other materials. In addition, the conductivity of the carbon material is high. Therefore, the Si layers 1022a provide a high capacity while the carbon material layers 1022b provide a good conductivity and a strong structure. As a result, by alternately stacking the Si layer 1022a and the carbon material layer 1022b, the stack 1022 provides an anode with good electrochemical performance while keeping the conductivity and the structure in a good state. In consideration of that the Si layer 1022a tends to be oxidized to form SiO₂, the last layer of the stack 1022 can be the carbon material layer 1022b to protect the stack 1022.

The stack 1022 is formed on a base 1021, for example, a metallic foil which can provide a lower resistance for the anode 102. To be more specific, both the Si layer 1022a and the carbon material layer 1022b are formed on a copper foil by a vapor deposition method in this embodiment. The LiPON layer is then formed on the stack 1022. The LiPON layer is formed by a sputtering method with a Li₃PO₄ target. The sputtering method can be radio frequency (RF) magnetic sputtering method under nitrogen atmosphere using a Li₃PO₄ target, the power is from 70 W to 80 W, and a pressure from 4 mtorr to 6 mtorr. In the present embodiment, the power is 75 W and the pressure is 5 mtorr. The LiPON layer formed by this method is effective to prevent the forming of a solid electrolyte interface on the anode surface so the anode formed by this method has a good electrochemical performance.

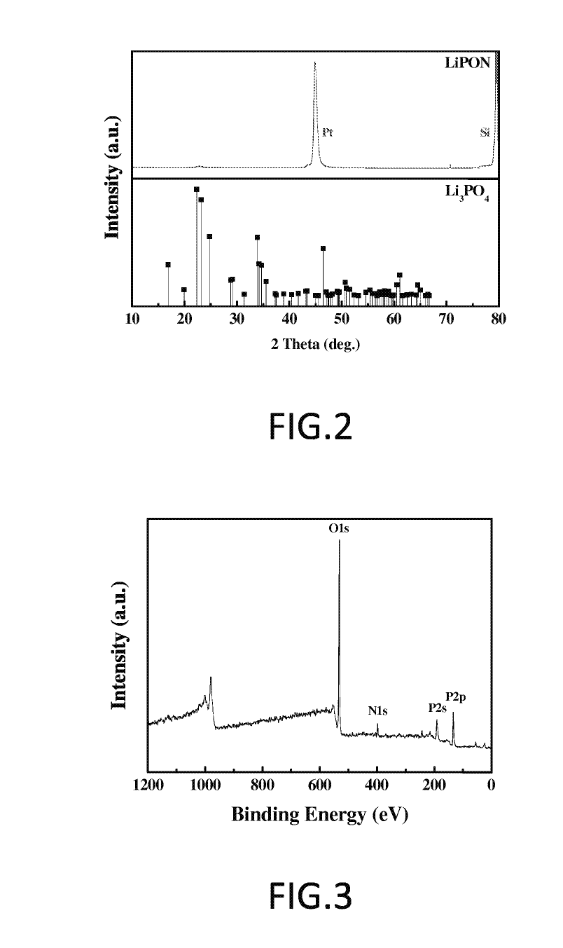

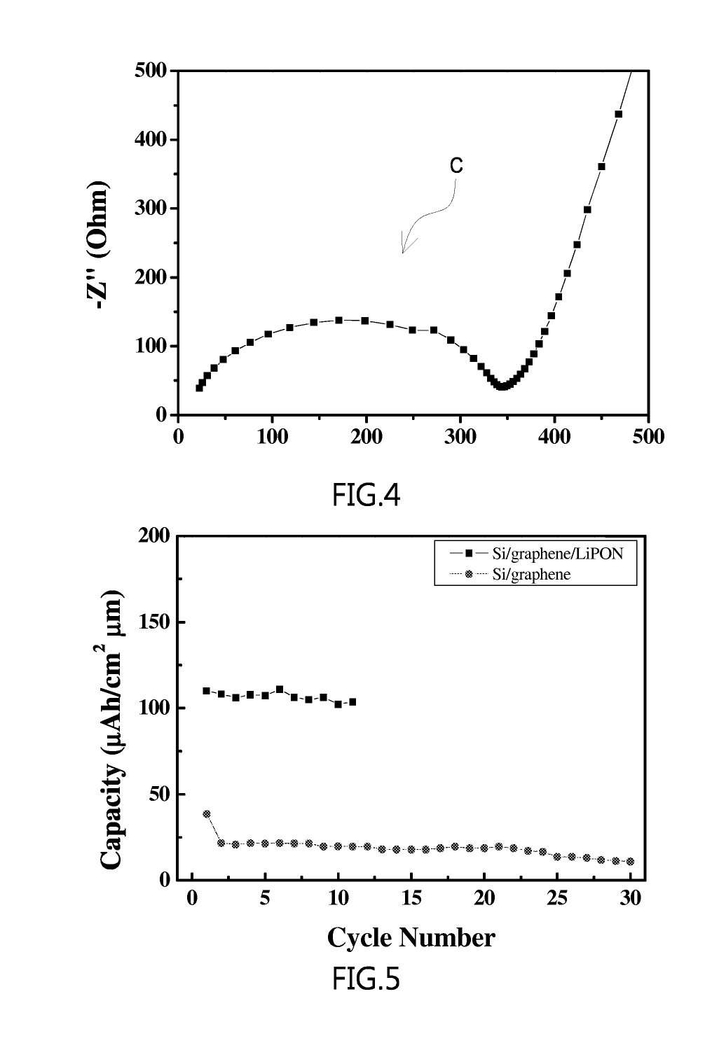

FIG. 2 shows the X-ray diffraction spectrum of LiPON formed by a method in accordance with one embodiment of the present application (the upper part) and the standard Li₃PO₄ target (the lower part). A comparison of the two spectrums shows clearly that the LiPON layer formed by this method comprises an amorphous structure because there is no spectrum signal corresponding to a lattice structure shown in the upper part besides Platinum (Pt) and Silicon (Si). The amorphous structure is advantageous to the passage of the lithium ions to increase the intercalation and deintercalation of the lithium ions at the anode so that the electrochemical performance is also raised. It is noted that because platinum has a lower resistance for an accurate impedance analysis which is illustrated in FIG. 4, here LiPON is formed on a Pt/Si substrate for both the X-ray diffraction spectrum and the impedance analysis. Platinum (Pt) and Silicon (Si) in the spectrum come from this Pt/Si substrate.

FIG. 3 shows the X-ray photoelectron spectroscopy of the LiPON layer formed by this method. The N1s in the figure indicates nitrogen element, and the P2s and P2p in the figure indicate phosphorous element. After an integration calculation, it is found that a ratio of nitrogen to phosphorous in the LiPON layer is between 0.3 and 0.5. In one embodiment, a ratio of nitrogen to phosphorous in the LiPON layer is 0.389. It shows that the LiPON layer formed by this method comprises a high ratio of nitrogen, which is in favor of the movement of the lithium ions.

FIG. 4 shows the impedance analysis of the LiPON layer formed by this method. The left part in the figure marked by “C” is an arc which approximates to a part of the circumference of a circle having a radius. An ionic conductivity of the LiPON layer is inversely proportional to the radius and can be calculated accordingly. The result of the impedance calculation shows an ionic conductivity of the LiPON layer formed by this method is larger than 1×10⁻⁶ S/cm. In one embodiment, an ionic conductivity of the LiPON layer formed by this method is 1.38×10⁻⁶ S/cm. It shows that the LiPON layer formed by this method provides a high ionic conductivity, which is in favor of the movement of the lithium ions.

FIG. 5 shows a comparison of the capacity of a device for producing an electric current of the present embodiment with that of a conventional device for producing an electric current. The anode of the conventional device for producing an electric current comprises a stack formed by alternately stacking of Si layers and graphene layers. The anode of the conventional device does not comprise a LiPON layer. It is clear that the conventional device has a smaller capacity, and has a large initial irreversible capacity loss after the first charging and discharging cycle. The capacity of the conventional device drops from 38 (μAh/(cm²*μm)) to about 25 (μAh/(cm²*μm)) after the first charging and discharging cycle. The initial irreversible capacity loss is about 34% (=(38−25)/38). In comparison, the capacity of the device of the present embodiment drops from 111 (μAh/(cm²*μm)) to about 105 (μAh/(cm²*μm)) after the first charging and discharging cycle. The initial irreversible capacity loss is about 5.4% (=(111−105)/111). It is found that the device for producing an electric current of the present embodiment has an initial irreversible capacity loss small than 10%, and a capacity larger than 75 (μAh/(cm²*μm)).

The method of making a device for producing an electric current of the present embodiment provides an anode having good electrochemical performance for a device for producing an electric current. A solid electrolyte interface is inhibited to form on the anode surface, so the device for producing an electric current of the present embodiment has a larger capacity and a smaller initial irreversible capacity loss.

The embodiments described above are only for illustration, and it is apparent that other alternatives, modifications and materials may be made to the embodiments without escaping the spirit and scope of the application.

What is claimed is:

1. A device for producing an electric current, comprising:
an anode comprising a stack formed by alternately stacking of at least one Si layer and at least one carbon material layer, and a LiPON layer on the stack;
a cathode; and
an electrolyte between the anode and the cathode.

2. The device for producing an electric current as claimed in claim 1, wherein an initial irreversible capacity loss is small than 10%.

3. The device for producing an electric current as claimed in claim 1, wherein the cathode comprises LiCoO₂, LiFePO₄, LiNiO₂, and/or LiMn₂O₄.

4. The device for producing an electric current as claimed in claim 1, wherein the anode further comprises a Cu layer on which the stack is disposed on.

5. The device for producing an electric current as claimed in claim 1, wherein the stack is formed by alternately stacking of five Si layers and six carbon material layers.

6. The device for producing an electric current as claimed in claim 1, wherein the LiPON layer is formed by sputtering with a Li₃PO₄ target.

7. The device for producing an electric current as claimed in claim 1, wherein the LiPON layer comprises an amorphous structure.

8. The device for producing an electric current as claimed in claim 1, wherein a ratio of nitrogen to phosphorous in the LiPON layer is between 0.3 and 0.5.

9. The device for producing an electric current as claimed in claim 1, wherein an ionic conductivity of the LiPON layer is larger than 1×10⁻⁶ S/cm.

10. The device for producing an electric current as claimed in claim 1, wherein a capacity thereof is larger than 75 μAh/(cm²*μm).

11. A method for forming a device for producing an electric current, comprising:
providing an anode, comprising:
forming a stack formed by alternately stacking of at least one Si layer and at least one carbon material layer; and
forming a LiPON layer on the stack;
providing a cathode; and
providing an electrolyte between the anode and the cathode.

12. The method as claimed in claim 11, wherein the stack is formed by alternately stacking of five Si layers and six carbon material layers.

13. The method as claimed in claim 11, wherein the LiPON layer is formed by a sputtering method with a Li₃PO₄ target.

14. The method as claimed in claim 13, wherein the sputtering method is a radio frequency (RF) magnetic sputtering method.

15. The method as claimed in claim 13, wherein a power for the sputtering method is in a range of from 70 W to 80 W, and a pressure for the sputtering method is in a range of from 4 mtorr to 6 mtorr.

16. The method as claimed in claim 11, wherein the LiPON layer comprises an amorphous structure.

17. The method as claimed in claim 11, wherein a ratio of nitrogen to phosphorous in the LiPON layer is in a range of from 0.3 to 0.5.

18. The method as claimed in claim 11, wherein an ionic conductivity of the LiPON layer is larger than 1×10⁻⁶ S/cm.

19. The method as claimed in claim 11, wherein the cathode comprises LiCoO₂, LiFePO₄, LiNiO₂, and/or LiMn₂O₄.

20. The method as claimed in claim 11, wherein an initial irreversible capacity loss of the device for producing an electric current is small than 10%, and a capacity of the device for producing an electric current is larger than 75 μAh/(cm²*μm).
